(19) United States
(12) Patent Application Publication
(10) Pub. No.: US 2026/0268248 A1
(43) Pub. Date: Sep. 10, 2026

(54) Project Plan Optimization Tool and Project Plan Optimization Method

(71) Applicant: Astemo, Ltd., Chiyoda-ku, Tokyo (JP)

(72) Inventors: Kenji KITAGAWA, Tokyo (JP); Masumi KAWAKAMI, Tokyo (JP); Hajime SAITO, Ibaraki (JP); Tomomi OKAMOTO, Ibaraki (JP)

(21) Appl. No.: 19/165,626

(22) PCT Filed: Apr. 12, 2024
(86) PCT No.: PCT/JP2024/014843

§ 371 Date: Sep. 16, 2025

(30) Foreign Application Priority Data
Jun. 30, 2023 (JP) 2023-108268

(51) Int. Cl. G06Q 10/0631; G06Q 10/10

(52) U.S. Cl. CPC G06Q 10/06313; G06Q 10/103

(57) ABSTRACT

There is provided a project plan optimization tool comprising a plan value parameter input unit to which a first plan value parameter for each phase obtained by dividing the project into a plurality of phases is input; a past record information accumulation unit that accumulates record value parameters and result evaluation values of each phase in a plurality of past projects; a past record information analysis unit that analyzes the record value parameters and the result evaluation values of each phase in the past projects in association with each other, and generates a prediction model of the project; a project result prediction unit that predicts a result evaluation value from the first plan value parameter by using the prediction model; and a plan value parameter optimization unit that re-distributes the first plan value parameter between the phases and outputs an optimized second plan value parameter.

### INCORPORATION BY REFERENCE

The present application claims priority from Japanese patent application JP 2023-108268 filed on Jun. 30, 2023, the content of which is hereby incorporated by reference into this application.

### TECHNICAL FIELD

The present invention relates to a projecting optimization plan optimization tool that optimizes a plan value parameter based on project result prediction in planning a project.

### BACKGROUND ART

In a software development project, data utilization for performing analysis and determination based on accumulated record values of project management data is performed. As a result, a project plan can be efficiently promoted, and the risk can be detected at an early stage by the prediction technique.

A project result prediction technique of collating a plan value with accumulated record values and predicting a result in planning a project has been developed. Although there are various prediction methods, a past project similar to or close to a new project desired to be predicted is searched from the accumulated project management data group, and the evaluation value of the project is predicted based on the searched management data of the past project.

At this time, the accumulated data includes an explanatory variable used to find similarity and an objective variable that is an item to be predicted. An explanatory variable is a value based on the nature and development content of the project, and is, for example, a product category, a scale of development, or the like. On the other hand, an objective variable is an evaluation value indicating the result of a development project, and is man-hours, cost, or the like determined at the end of the past project.

The relationship between the explanatory variable and the objective variable can be regarded as a causal relationship based on a rule, and, in the project result prediction technique, the relationship between the explanatory variable and the objective variable is handled as a prediction model. In the project result prediction technique, the prediction model receives an input of the explanatory variable of a project to be predicted, and outputs a prediction value of a result evaluation value as the objective variable. Although the prediction technique may be applied at the start of a project, there is an explanatory variable having difficulty in being determined at the start of the project, and a part thereof is input as a plan value.

Background art of the present technical field includes the following prior art. PTL 1 (JP 2022-32115 A) discloses a project sign detection device including: a storage device that retains each piece of information regarding a content and a profit and loss of each past project; and an arithmetic device that executes processing of extracting each piece of the information of each past project from the storage device and generating, by machine learning, a decision tree for each explanatory variable, in which a value of one or a plurality of items determined in advance in the content among the pieces of the information is set as an explanatory variable and a situation of the profit and loss among the pieces of the information is set as an objective variable, and processing of extracting a value of an item corresponding to the explanatory variable of the decision tree among the pieces of the information of the content of a target project, inputting the extracted value to the corresponding decision tree, and calculating a failure probability of the target project by a random forest algorithm.

### SUMMARY OF INVENTION

### Technical Problem

The project result prediction technique as described above is used for making a project plan. The validity of a plan is supported by planning a project based on an appropriate plan value that gives a favorable result in the project result prediction technique. For example, a result based on a plan value created by a person can be checked by the project result prediction technique, and it can be confirmed whether the plan is unreasonable. In addition, the plan value can be updated and predicted again as necessary, and adjustment can be made such that a better prediction result can be obtained.

On the other hand, in many cases, a development project is managed by being divided into a plurality of phases separated by development and release timings in time series. At the time of project planning, a requirement of allocation of a plan value such as a development scale, a period, a budget, and personnel assumed in advance to each phase is newly required. The project result prediction technique can be applied to each phase. In that case, an explanatory variable in units of phases can be input and a prediction value of a result evaluation value can be output as an objective variable for each phase. For one objective variable, the transition in units of phases can be confirmed throughout the project when viewed as the entire project plan. For example, it is possible to obtain a prediction result from the viewpoint of in which phase a burden is likely to occur. Upon receiving such a result, a plan value is adjusted, and measures such as smoothing of a burden between phases and countermeasures against a risk in units of phases are required.

In order to adjust the input value of the explanatory variable so that the prediction value of the result evaluation value in units of phases becomes a value desirable for the user after the result is predicted in the units of phases in which the project is divided, the cost of trial and error is large, and a technique for automatically performing this optimization is required.

### Solution to Problem

### Advantageous Effects of Invention

According to one aspect of the present invention, it is possible to optimize a plan value parameter of a project. Problems, configurations, and effects other than those described above will be clarified by the following description of embodiments.

### BRIEF DESCRIPTION OF DRAWINGS

FIG. 1 is a diagram illustrating an overall configuration of a project plan optimization tool of an embodiment of this invention.

FIG. 2 is a flowchart of optimization processing of the embodiment of this invention.

FIG. 3 is a diagram illustrating a plurality of phases constituting a project of the embodiment of this invention.

FIG. 4 is a diagram illustrating definition of a project plan value and result prediction for each phase of the embodiment of this invention.

FIG. 5 is a configuration example of a movement rule table of the embodiment of this invention.

FIG. 6 is a configuration example of a goal definition table of the embodiment of this invention.

### DESCRIPTION OF EMBODIMENTS

### Embodiment 1

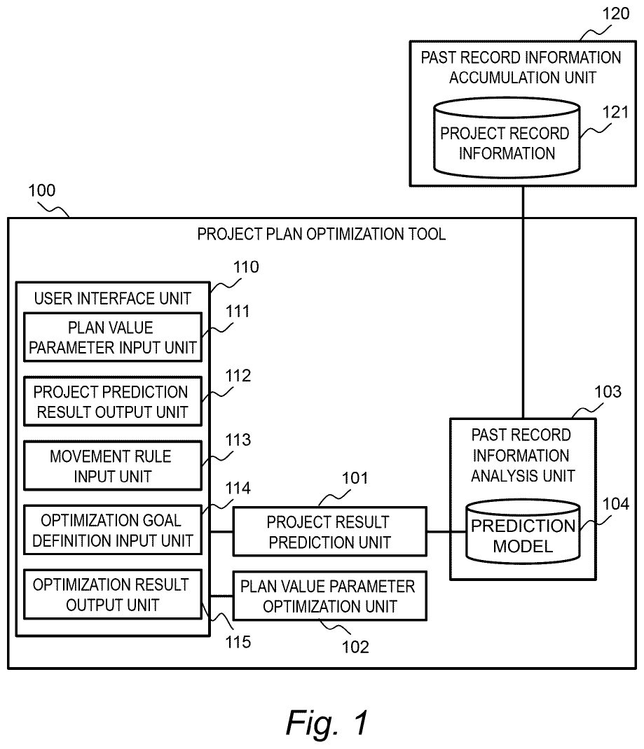

FIG. 1 is a diagram illustrating an overall configuration of a project plan optimization tool 100 of the present embodiment.

The project plan optimization tool 100 includes a project result prediction unit 101, a plan value parameter optimization unit 102, a past record information analysis unit 103, and a user interface unit 110. The user interface unit 110 has a function of presenting an execution result of a program to a user via a display device or an input device and receiving an input from the user, and includes a plan value parameter input unit 111, a project prediction result output unit 112, a movement rule input unit 113, an optimization goal definition input unit 114, and an optimization result output unit 115. In addition, the past record information analysis unit 103 is connected to a past record information accumulation unit 120, refers to project record information 121, and retains a prediction model 104 that is an analysis result.

The project result prediction unit 101 has a function of predicting a result of a project by simulation of the project, and predicts a prediction result evaluation value of the plan value parameter input to the plan value parameter input unit 111 based on the prediction model 104. The predicted prediction result evaluation value is displayed on the project prediction result output unit 112.

The plan value parameter optimization unit 102 re-distributes the plan value parameter to the prediction result of the project result prediction unit 101 to optimize a prediction result. A constraint condition of the plan value parameter in optimization is acquired from the movement rule input unit 113, and a goal condition for optimization is acquired from the optimization goal definition input unit 114. A result of optimization by the plan value parameter optimization unit 102 is output from the optimization result output unit 115.

The past record information analysis unit 103 analyzes the project record information 121 retained by the past record information accumulation unit 120, and generates and retains the prediction model 104.

More specifically exemplified on the premise of a software development project, in the past record information, as project parameters, a wide variety of types of information such as a period that can be an explanatory variable of the prediction model, a development scale (number of development lines and number of requirements), a product category, a distinction between new development and derivative development, a safety/security level, and an execution environment scene (OS or CPU) are accumulated. In addition, as result information that can be an objective variable, final man-hours, cost (amount of money), quality (defect information), delivery date, and the like are stored. The past record information analysis unit 103 models a causal relationship in the explanatory variable and the objective variable group to generate and retain the prediction model 104. A machine learning technique can be used as one generation means. Generally, in such a case, supervised machine learning regression analysis is used, and a prediction model is generated by performing learning with an explanatory variable and an objective variable as teacher data.

The project plan optimization tool 100 of the present embodiment is configured by a computer including a processor (CPU), a memory, an auxiliary storage device, a communication interface, an input interface, and an output interface.

The processor is an arithmetic device that executes a program stored in the memory. Functions of the functional units (for example, the project result prediction unit 101, the plan value parameter optimization unit 102, the past record information analysis unit 103, and the like) of the project plan optimization tool 100 are implemented by the processor executing various programs. Note that a part of processing performed by the processor executing the program may be executed by another arithmetic device (for example, hardware such as an ASIC and an FPGA).

The memory includes a ROM that is a nonvolatile storage element and a RAM that is a volatile storage element. The ROM stores an invariable program (for example, BIOS) and the like. The RAM is a high-speed and volatile storage element such as a dynamic random access memory (DRAM), and temporarily stores a program executed by the processor and data used when the program is executed.

The auxiliary storage device is, for example, a large-capacity nonvolatile storage device such as a magnetic storage device (HDD) or a flash memory (SSD). In addition, the auxiliary storage device stores data used when the processor executes the program and the program executed by the processor. That is, the program is read from the auxiliary storage device, loaded into the memory, and executed by the processor, thereby implementing each function of the project plan optimization tool 100.

The communication interface is a network interface device that controls communication with other devices in accordance with a predetermined protocol.

The input interface is an interface that receives an input from the user, such as a keyboard or a mouse. For example, the input interface receives an input of a file in which cost data is recorded, the file being stored in the auxiliary storage device. In addition, the input interface may provide a GUI and receive an input of cost data from the user.

The output interface is an interface such as a display device or a printer, which outputs an execution result of the program in a format that can be visually recognized by the user. For example, the output interface outputs the execution result of the program. In addition, the output interface may be a data output port that outputs the execution result of the program in a form that can be visually recognized by the user.

Note that a terminal connected to the computer via a network may provide the input interface and the output interface.

The program executed by the processor is provided to the computer via a removable medium (CD-ROM, flash memory, and the like) or a network, and is stored in the nonvolatile auxiliary storage device that is a non-transitory storage medium. Therefore, the computer preferably has an interface for reading data from the removable medium.

The project plan optimization tool 100 is a computer system that is configured on physically one computer or configured on a plurality of computers configured logically or physically, and may operate on a virtual computer constructed on a plurality of physical computer resources. For example, the project result prediction unit 101, the plan value parameter optimization unit 102, and the past record information analysis unit 103 may operate on separate physical or logical computers, or a plurality of units may operate on one physical or logical computer.

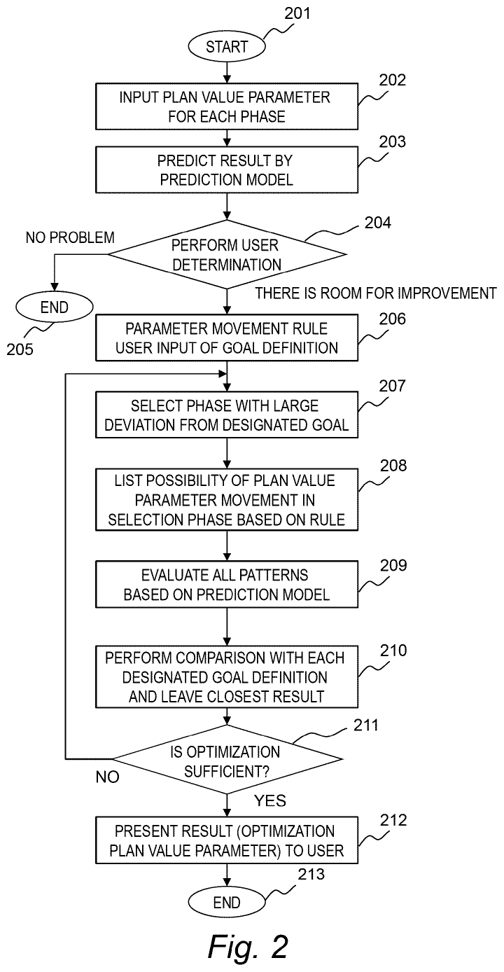

FIG. 2 is a flowchart of optimization processing of the present embodiment.

The optimization processing illustrated in FIG. 2 starts in a state where the prediction model 104 serving as a premise of the processing has been generated by the past record information analysis unit 103 (201).

When the processing is started, in Step 202, an input of the plan value parameter of each phase constituting the project is received from the plan value parameter input unit 111.

In Step 203, the project result prediction unit 101 predicts a result evaluation value by using the prediction model 104 for the plan value parameter and predicts a result of the project. The result of the project is predicted in units of phases, and a series of prediction values corresponding to the number of phases constituting the project for one type of prediction target objective variable is output.

In Step 204, the predicted result evaluation value is presented to the user, and whether or not it is necessary to continue the optimization processing is confirmed. When it is not necessary to continue the optimization processing, the processing ends (205).

In Step 206, as a user input, a plan value parameter movement rule is received from the movement rule input unit 113, and a goal definition for optimization is received from the optimization goal definition input unit 114.

In Step 207, it is evaluated how much deviation the series of prediction values generated in Step 203 or Step 210 to be described later has with respect to the input goal definition for optimization. For example, the deviation can be determined based on a difference of the corresponding prediction value from a numerical string in which the goal definition can be changed. At that time, one phase having the largest deviation is selected and stored as a selection phase in the subsequent step.

In Step 208, in accordance with the plan value parameter movement rule between phases, the possibility of movement of the plan value parameter of the selection phase is evaluated, and a plan value parameter candidate after the movement is prepared. This processing is executed for all applicable movement rules, and a plan value parameter group obtained by combining plan value parameter candidates is listed and stored as a pattern.

In Step 209, the result evaluation value is sequentially predicted by the project result prediction unit 101 for patterns of all the plan value parameter groups. A series of predicted result evaluation values for all patterns can be obtained.

In Step 210, collation with the optimization goal definition is performed, and a result closest to all the predicted result evaluation values is recorded.

In Step 211, it is determined whether sufficient optimization has been performed. This determination may be made by using the closeness to the optimization goal definition in the comparison in Step 210 with a predetermined threshold value, or it may be determined that the sufficiency is satisfied by the number of repetitions from Step 207. As a result, when the optimization is insufficient, the processing returns to Step 207 and the processing is repeated.

When it is determined in Step 211 that the optimization is sufficient, the optimized plan value parameter that is a result of the optimization is presented to the user in Step 212, and the processing ends (213).

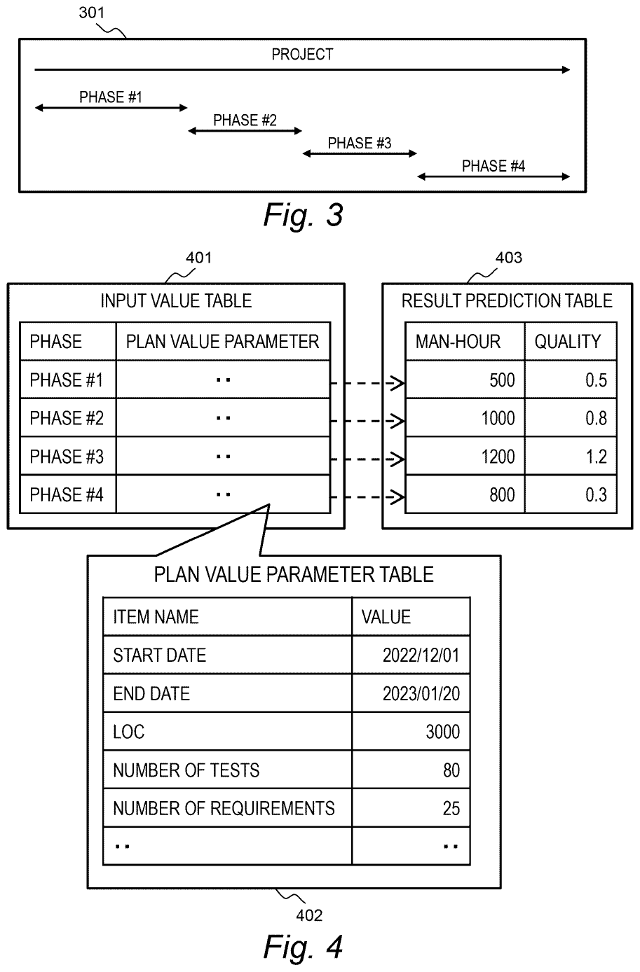

A specific example of processing performed by the project result prediction unit 101 will be described with reference to FIGS. 3 and 4. This processing is performed in Steps 203 and 209.

FIG. 3 is a diagram illustrating a plurality of phases constituting a project. The horizontal axis is a time axis of the project, and four phases are defined on the time axis. Although each phase exists in a form in which a project is divided on the time axis, a period of each face is not clearly separated from a certain date, and periods of preceding and subsequent phases may overlap, or conversely, there may be gaps between phases.

FIG. 4 is a diagram illustrating definition of a project plan value and result prediction for each phase illustrated in FIG. 3.

In Step 202, the plan value parameter of each phase including an input value table 401 and a plan value parameter table 402 is input to the plan value parameter input unit 111.

In Step 209, a plurality of patterns of a plan value parameter group corresponding to the input value table 401 and the plan value parameter table 402 are created in accordance with the movement rule. These are candidates for optimization. The result of the prediction using the patterns is retained in the same data structure as a result prediction table 403.

In Step 210, the input value table 401, the plan value parameter table 402, and the result prediction table 403 are retained for use in subsequent processing with a set of plan value parameters that are an appropriate result at that time. In a case where the optimization is continued, the value of the retained table is used in Step 207 and Step 208. In a case of proceeding to Step 212, the value of the retained table is used.

The input value table 401 retains the plan value parameter for each phase. Each plan value parameter has a configuration like the plan value parameter table 402, and the plan value is stored in a definition item. In the plan value parameter table 402, a different instance is created for each row of the input value table 401, and information of each phase is retained.

The project result prediction unit 101 acquires information retained in the input value table 401 and the plan value parameter table 402 for each phase, predicts the project result (man-hours or quality) by using the prediction model 104, and stores the prediction value in the result prediction table 403. In a case where there are a plurality of types of targets to be predicted, a prediction value is stored for each prediction target. FIG. 4 illustrates an example of predicting two types of prediction targets of man-hours and quality.

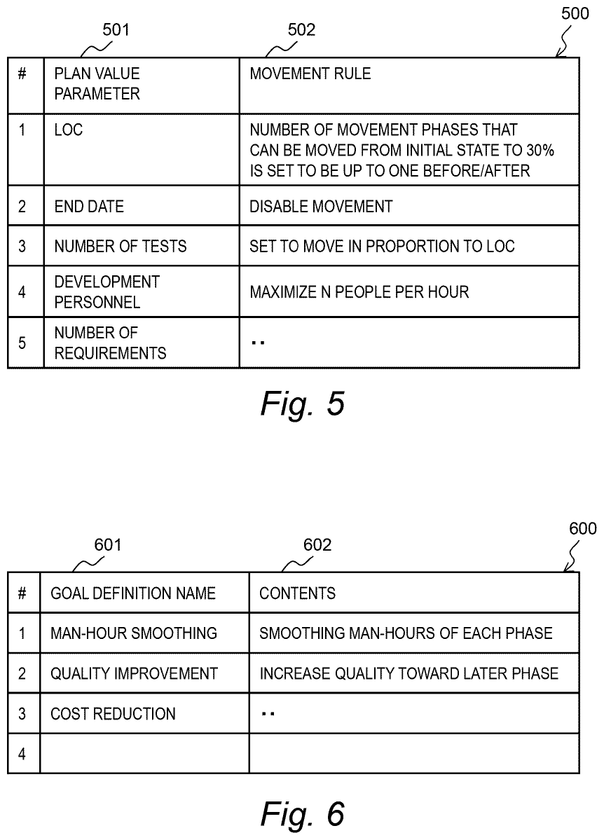

A movement rule table 500 will be described with reference to FIG. 5.

The movement rule table 500 in which the movement rule of the plan value parameter is defined includes a plan value parameter 501 and a movement rule 502 thereof, and a movement rule input by the user to the movement rule input unit 113 is recorded as a rule exemplified below for each type of plan value parameter. The movement rule table 500 is stored in the memory of the computer on which the project plan optimization tool 100 is implemented.

In the example shown in the first line, a plan value parameter “LOC” has two rules of “enabling movement from the initial state to 30%” and “setting a distance of the movement phase to one before and after”. LOC is an abbreviation of Line of Code and represents the number of lines. In the former rule, the maximum value of the amount when the plan value parameter LOC is moved in Step 208 is designated, and for example, the rule is set to a case where the plan value in the initial input in Step 202 having 1000 rows can be moved by optimization up to front and rear 30%, that is, up to 300 rows.

In addition, the latter is a rule related to a range of a movement destination phase that enables movement of the plan value parameter only with respect to a phase adjacent before and after a selection phase when movement of the plan value parameter is examined in Step 208 by using the selection phase in Step 207 as a target.

In the example shown in the second line, the plan value parameter “end date” indicates that the movement is not possible, and is not a target of the movement possibility examination in Step 208. Among the project plan values, there are plan value parameters that are not variable depending on the nature and organization convenience. Such a rule can also be defined.

In the example shown in the third line, a rule of “moving in proportion to LOC” is defined for the plan value parameter “number of tests”. The respective plan value parameters are not independent, and may have a correlation relationship related to each other. In such a case, it is desirable to maintain the relation between the plan value parameters at the time of examining a movement amount in Step 208. In this example, the LOC and the number of tests are proportional to each other, and the rule is to examine the possibility of movement while maintaining a proportional relationship between both the plan value parameters of the LOC value and the number of tests. Such a mutual relationship may be a relation among three or more parties.

In the example shown in the fourth line, a numerical range of values unique to the plan value parameter is defined. In the example illustrated in FIG. 3, the upper limit value of the number of development staffs is set to N people per unit time, and in Step 208, the movement of the plan value that does not exceed this number is examined.

As described above, four examples are shown in the movement rule table 500, but a rule when the plan value parameter is moved between phases in such a format can be designated in Step 206.

In the example illustrated in FIG. 5, the rule is described in the natural language, but a template of such a rule may be prepared in advance on the user interface, and the rule is preferably implemented in a format such as selection of a template and detailed designation by numbers. The template indicates a rule definition in a format such as “movable by X % from an initial state” or “move in proportion to X”, and has a form in which a numerical value of X or a target is input after the template is selected on the user interface. This template can be prepared without depending on a specific plan value parameter.

The user generates the movement rule table 500 in which movement rules are defined by sequentially giving rules to the respective plan value parameters. Note that it is also assumed that the rules are fixedly operated to some extent by the organization. In such a case, a movement rule defined in a table prepared in advance may be read, and the read movement rule may be customized and used.

Based on the definition of the movement rule table 500 illustrated in FIG. 5, a parameter movement pattern is generated in Step 209. For example, when the movement rule is “movable from the initial state to 30%”, the movement amount candidate is selected in a range of 30%. Although a plurality of approaches can be considered, if the approaches are collectively performed within a range, the possible range of the movement amount is divided at equal intervals (for example, equally divided into 10 pieces) to create a group of candidates. Further, a combination of the amounts of forward and backward movement is created as the group of candidates in accordance with the rule “up to one forward and backward movement phase”. In Step 209, candidates are similarly created for the subsequent movement rules, prediction is performed by using the prediction model 104 for all patterns of the plan value parameter group derived by the combination of the candidates, and an appropriate plan value parameter is found in Step 210. It is preferable to evaluate all combinations, but it is assumed that the amount of calculation increases as the number of combinations increases, and it is preferable to suppress the increase in the amount of calculation by a method of selectively evaluating a pattern with a random number or the like or a method of preferentially incorporating a candidate group having a small difference from the initial state into a pattern. In addition, the priority of the explanatory variable that affects the target goal definition may be ascertained by using the information of the causal relationship in the prediction model 104, and, in this state, the pattern may be created in accordance with the order.

A goal definition table 600 will be described with reference to FIG. 6.

In the goal definition table 600, the content of the goal definition input by the user in Step 206 is recorded. The goal definition table 600 includes a goal definition name 601 that is a name for identifying a goal definition and the content 602 thereof. In Step 210, the goal definition and the prediction result are collated with each other to evaluate the degree of achievement in the optimization.

In the example of the man-hour smoothing shown in the first line, the goal is that the man-hours predicted in each phase as the objective variable become equal throughout the project. At the time of the user input, the goal definition may be designated by a template similar to the natural language or the above-described movement rule as in the content 602. At the time of the evaluation in Step 210, the objective variable designated in the content 602 of the goal definition is re-expressed as a numerical value as a result of the series for each phase. In the man-hour smoothing, the goal is that the prediction result of the man-hours of each phase falls within a predetermined error range with the average value of the man-hours of each phase. In Step 210, the prediction result with the smallest difference in man-hours of each phase and the plan value parameter after movement at that time are selected.

In the example of the quality improvement shown in the second line, the goal is that the quality is improved in a later phase in time series. In this goal definition, unlike the example of man-hours described above, a goal numerical value inclined according to the position of each phase on the time axis is determined. The slope of the numerical value may be an implicitly prescribed value or may be designated by the user. When bug density or the number of bugs is used as a quality index, it is desirable that the quality index be reduced in accordance with the transition of time toward completion. The quality index of each phase may be calculated as the goal numerical value according to the slope defined as the quality index (bug density, number of bugs) predicted for the entire project.

As illustrated in FIG. 6, the goal definition is individually determined for a plurality of objective variables. Therefore, in the determination in Step 211, the closeness between the calculated objective variable and each goal definition shown in the goal definition table 600 is evaluated. In the simplest manner, the case where the average of a difference between the calculated objective variable and each goal definition value is the smallest is preferably selected as the solution. The goal definition may be defined by a combination of a plurality of conditions.

In addition, a priority may be given to each goal definition, and a weighted average value based on the priority may be used. As a result, in Step 210, a solution focusing on a goal definition with a higher priority can be selected.

As described above, according to the project plan optimization tool of the embodiment of the present invention, the plan value parameter can be re-distributed between the phases by the movement of the plan value between the plurality of phases constituting the project, and the plan value parameter can be optimized. In addition, an appropriate plan value parameter that ensures the validity of the plan value can be obtained by the movement rule of the plan value. Furthermore, a form of plan value transition desired by the user is input as the target goal, and the plan value is brought close to the target goal within a range allowed by the movement rule. Thus, the plan value parameter that derives the result of the project desired by the user is obtained.

### Embodiment 2

In Embodiment 1, the candidate group for re-distribution of the plan value parameter is generated with the movement rule illustrated in FIG. 3 as a constraint condition, and finding of the plan value parameter for deriving an appropriate prediction result is limited to the candidate group under this constraint condition. However, there may be a calculation value parameter that derives an appropriate prediction result even when some constraints are released. At that time, when the released constraint is allowed, the optimized calculation value parameter obtained there can also be used. In the present embodiment, when the possibility patterns of the parameter movement in Step 208 are listed, if a combination of parameters to be re-distributed within a range of a rule deviation condition of 50% is searched for with respect to a movement rule that intentionally deviates from the movement rule, for example, a movement rule in a range of “30% from the initial state” in FIG. 5, it is conceivable that a more appropriate result can be obtained than in a case of conforming to the movement rule.

In a case where an appropriate result is found by such deviation of the movement rule, in the result display of Step 212, the result of the deviation of the movement rule and the result conforming to the movement rule may be compared and displayed together with the deviated movement rule, and the user may be caused to determine whether or not the deviation of the movement rule is possible.

Note that, among the movement rules, there are a strict movement rule that does not allow deviation and a movement rule that allows deviation to some extent. It is possible to search for a solution without waste by adding designation as to whether to permit a trial deviating from the movement rule to the definition of the movement rule illustrated in FIG. 3.

### Modification Examples of Present Invention

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration. Note that the present invention is not limited to the above-described embodiments, and includes various modification examples and equivalent configurations within the spirit of the appended claims. For example, the above-described embodiments have been described in detail for easy understanding of the present invention, and the present invention is not necessarily limited to those having all the described configurations. Further, a part of the configuration of one embodiment may be replaced with the configuration of another embodiment. In addition, the configuration of another embodiment may be added to the configuration of a certain embodiment. In addition, a part of the configuration of each embodiment may be added, deleted, or replaced with another configuration.

The above-described configurations, functions, processing modules, and processing means, for all or a part of them, may be implemented by hardware: for example, by designing an integrated circuit, and may be implemented by software, which means that a processor interprets and executes programs providing the functions. In addition, a part or all of the above-described configurations, functions, processing units, processing means, and the like may be realized by hardware by, for example, designing with an integrated circuit, or may be realized by software by a processor interpreting and executing a program for realizing each function.

The information of programs, tables, and files to implement the functions may be stored in a storage device such as a memory, a hard disk drive, or an SSD (a Solid State Drive), or a storage medium such as an IC card, an SD card or a DVD. Information such as a program, a table, and a file for realizing each function can be stored in a storage device such as a memory, a hard disk, and an SSD (Solid State Drive), or a recording medium such as an IC card, an SD card, and a DVD.

The drawings illustrate control lines and information lines as considered necessary for explanation but do not illustrate all control lines or information lines in the products. It can be considered that almost of all components are actually interconnected.

1. A project plan optimization tool that outputs information regarding an improvement proposal for a business plan of a project,
wherein the project plan optimization tool is configured by a computer including an arithmetic device that executes arithmetic processing and a storage device that is accessible by the arithmetic device, and
the project plan optimization tool comprises:
a plan value parameter input unit to which a first plan value parameter for each phase obtained by dividing the project into a plurality of phases is input;
a past record information accumulation unit that accumulates record value parameters and result evaluation values of each phase in a plurality of past projects;
a past record information analysis unit that analyzes the record value parameters and the result evaluation values of each phase in the past projects in association with each other, and generates a prediction model of the project;
a project result prediction unit that predicts a result evaluation value from the first plan value parameter by using the prediction model; and
a plan value parameter optimization unit that re-distributes the first plan value parameter between the phases and outputs an optimized second plan value parameter.

2. The project plan optimization tool according to claim 1, wherein
the past record information analysis unit
analyzes the record value parameter and the result evaluation value accumulated in the past record information accumulation unit by machine learning for each phase, and
generates the prediction model that has learned a causal relationship between the record value parameter and the result evaluation value.

3. The project plan optimization tool according to claim 1, wherein
the project result prediction unit calculates a plurality of result evaluation values by simulation of a plurality of projects with a plurality of plan value parameters, and
the plan value parameter optimization unit selects a result evaluation value close to a goal definition set along a target of the project, and outputs a second plan value parameter corresponding to the selected result evaluation value.

4. The project plan optimization tool according to claim 3, wherein the plan value parameter optimization unit determines that optimization has been completed by the goal definition and selection of a result evaluation value within an error range set in advance, and outputs the second plan value parameter corresponding to the selected result evaluation value.

5. The project plan optimization tool according to claim 3, wherein the goal definition is defined by a combination of a plurality of conditions, and priorities are designated for the plurality of conditions.

6. The project plan optimization tool according to claim 3, wherein the goal definition is transition of an evaluation value according to a position of each phase on a time axis in the project.

7. The project plan optimization tool according to claim 1, wherein
the plan value parameter optimization unit
searches for a combination of movements of the plan value parameter between phases, the plan value parameter being for deriving an appropriate result evaluation value, based on a movement rule set in advance for each type of plan value parameter, and
outputs a second plan value parameter based on the searched combination.

8. The project plan optimization tool according to claim 7, wherein the movement rule is allowed to designate at least one of availability of movement of the plan value parameter, a movable amount of the plan value parameter, a range of a movement destination phase of the plan value parameter, and a numerical range after movement of the plan value parameter.

9. The project plan optimization tool according to claim 7, wherein the movement rule includes a rule for maintaining a relation between a plurality of plan value parameters having a correlation relationship.

10. The project plan optimization tool according to claim 7, wherein
the plan value parameter optimization unit
searches for a combination of re-distribution of plan value parameters in a range deviating from the movement rule, and
derives the second plan value parameter to which a movement rule deviation condition is attached.

11. A project plan optimization method executed by a project plan optimization tool that outputs information regarding an improvement proposal for a business plan of a project,
wherein the project plan optimization tool is configured by a computer including an arithmetic device that executes arithmetic processing and a storage device that is accessible by the arithmetic device,
the storage device includes a past record information accumulation unit that accumulates a record value parameter and a result evaluation value of each phase in a plurality of past projects, and
the project plan optimization method comprises:
a plan value parameter input step in which a first plan value parameter for each phase obtained by dividing the project into a plurality of phases is input;
a past record information analysis step of analyzing the record value parameters and the result evaluation values of each phase in the past projects in association with each other and generating a prediction model of the project;
a project result prediction procedure of predicting a result evaluation value from the first plan value parameter by using the prediction model; and
a plan value parameter optimization step of re-distributing the first plan value parameter between the phases and outputting an optimized second plan value parameter.
